(19) United States
(12) Patent Application Publication
(10) Pub. No.: US 2020/0038974 A1
(43) Pub. Date: Feb. 6, 2020

(54) Method Tool And Method Of Operating A Machine Tool

(71) Applicants: Martin Huber, Pfarrwerfen (AT); Alfons Wörmer, Bischofshofen (AT)

(72) Inventors: Martin Huber, Pfarrwerfen (AT); Alfons Wörmer, Bischofshofen (AT)

(21) Appl. No.: 16/488,274

(22) PCT Filed: Mar. 15, 2018
(86) PCT No.: PCT/EP2018/056522

§ 371 Date: Aug. 23, 2019

(30) Foreign Application Priority Data
Mar. 17, 2017 (EP) 17161654.3

(51) Int. Cl. B23C 9/00; B23Q 1/44; A61C 13/00

(52) U.S. Cl. CPC B23C 9/00; A61C 13/0004; B23Q 1/44

(57) ABSTRACT

The invention relates to a machine tool (1), in particular a dental milling machine or mill-turning machine, comprising a spindle (10) for receiving a tool and a working arm (12) for receiving a workpiece and comprising at least one nozzle (14a) attached to the spindle (10), in particular with its outlet direction (R) substantially parallel to the axis of rotation (A) of the spindle (10), characterized in that a deflecting body (16) is attached to the spindle (10) or clamped therein, said deflecting body extending in particular at least partially in front of the nozzle (14a). Further, the invention relates to a method of operating the machine tool (1).

The invention relates to a machine tool. Further, the invention relates to a method of operating a machine tool.

Machine tools, in particular dental milling machines or mill-turning machines, comprising a spindle for receiving a tool and a working arm for receiving a workpiece and comprising at least one nozzle attached to the spindle, in particular with its outlet direction substantially parallel to the axis of rotation of the spindle, are considered to be known.

DE 16 90 554 discloses a machine tool for simultaneous electro-chemical machining of several surfaces of an electrically conductive workpiece which have already been machined in advance using electrically conductive tools which correspond to the surfaces to be machined, wherein the effective areas of each tool consist of two adjacent portions of which the portion which takes effect first is tilted in the feed direction in adaptation to the electro-chemical removal from the respective surface of the workpiece, and the other subsequent portion extends parallel to the feed direction of the tools, and that an insulation is provided at each tool adjacent to the portion mentioned last.

Further, DE 22 45 089 discloses a device for cleaning machine tools and the like comprising an air-tight container closed with an upper detachable lid in which a perforated basket is arranged for collecting solid parts, e.g. metal chips, a suction pump connected to the container, a multi-port valve with which either the suction side or the pressure side of the pump may be connected to the container, a suction hose connected to the container above the basket, said suction hose being closable by means of a check valve, and a discharge hose which is connected to an opening which is positioned close to the container floor, wherein the container comprises an upright longitudinal axis and has a uniform, preferably circular cross-section along its entire length, wherein the multi-port valve and the check valve are attached to the side of the container and wherein a connection for the discharge hose is arranged on the side of the container close to the container floor.

Thus, the invention is based on the task of providing an improved machine tool as well as an improved method of operating a machine tool which allow for effective cleaning of a work chamber of the machine tool.

The task is solved with a machine tool with the features of patent claim 1. The task is further solved with a method of operating a machine tool with the features of patent claim 15.

### DISCLOSURE OF THE INVENTION

The present invention provides a machine tool, in particular a dental milling machine or mill-turning machine, comprising a spindle for receiving a tool and a working arm for receiving a workpiece and comprising at least one nozzle attached to the spindle, in particular with its outlet direction substantially parallel to the axis of rotation of the spindle, wherein a deflecting body is attached to the spindle or clamped therein, said deflecting body extending in particular at least partially in front of the nozzle.

Further, the present invention provides a method of operating a machine tool, in particular a dental milling machine or mill-turning machine. The method comprises providing a spindle for receiving a tool and a working arm for receiving a workpiece. In addition, the method comprises providing at least one nozzle, which is attached to the spindle, in particular with its outlet direction substantially parallel to the axis of rotation of the spindle. Furthermore, the method comprises providing a deflecting body which is attached to the spindle or clamped therein and which extends in particular at least partially in front of the nozzle. Additionally, the method comprises applying the deflecting body with a fluid escaping from the at least one nozzle.

An idea of the present invention is to enable—by providing the deflecting body which is attached to the spindle or clamped therein and which is arranged in front of the nozzle—that the deflecting body may be impinged upon by the fluid escaping from the at least one nozzle in such a way that it is possible to deflect the fluid into certain regions of the work chamber of the machine tool to effectively clean the work chamber of the machine tool.

Advantageous embodiments and developments may be taken from the subclaims and from the description with reference to the Figures. According to a preferred development it is provided that at least two nozzles are attached to the spindle whose outlet directions point to one another obliquely and particularly point towards the axis of rotation of the spindle. Due to the tilted position of the nozzles it may be achieved advantageously that an impingement angle of a fluid jet onto the deflecting body is adjustable corresponding to respective requirements.

According to a further preferred development it is provided that the deflecting body is mounted pivotably and that it deflects a cleaning liquid escaping from the nozzles, and wherein the deflecting body acts as a deflector and deflects the cleaning liquid impinging on it upon its rotation in particular at least partially in the direction of its rotation. Thus, due to the effect of the deflecting body as a deflector in combination with its rotation around its axis of rotation, the cleaning liquid impinging thereon may be deflected advantageously into the work chamber of the machine tool such that uniform distribution of the cleaning liquid in the work chamber of the machine tool is enabled.

According to a further preferred development it is provided that a plurality of nozzles is arranged circularly around or at the spindle and that their outflow directions point towards the deflecting body. In this way, advantageously, the deflecting body may be impinged upon uniformly with cleaning liquid by the nozzles arranged circularly around it along its circumference.

According to a further preferred development it is provided that the spindle is connected non-rotatably with a spindle motor which is received in a spindle housing which is in particular substantially frusto-conical, wherein the nozzles are configured at the front surface of the spindle housing. Due to the arrangement of the spindle motor in the spindle housing, a compact arrangement of a spindle unit consisting of spindle, spindle motor and spindle housing may be provided preferably. The frusto-conical configuration of the spindle housing advantageously enables improved accessibility of the spindle by a working arm of the machine tool.

According to a further preferred development it is provided that the deflecting body comprises grooves which extend substantially parallel to the axis of rotation of the spindle, and wherein the deflecting body comprises at least one baffle whose normal extends substantially in the outlet direction of the nozzles, wherein the baffle acts atomizingly in particular with regard to impinging jets of the cleaning liquid. Due to the substantially perpendicular arrangement of the baffle of the deflecting body it may be ensured preferably that the cleaning liquid impinging upon the deflecting body is reflected substantially laterally and downwards in the direction of the spindle as well as the housing of the spindle when it impinges upon the baffle, whereby a region of side walls, floor areas, the spindle and the spindle housing are cleanable by the cleaning liquid atomized at the baffle.

According to a further preferred development it is provided that the baffle is configured at the end, in particular at the upper end, of the deflecting body and points towards the bottom when the spray jets of the cleaning liquid are directed towards the top. In this way, deflection or else redirection of the spray jets of the cleaning liquid towards the bottom may be ensured advantageously.

According to a further preferred development it is provided that the machine tool comprises a control system to clean the machine tool, said control system turning on a cleaning process when the spindle is equipped with the deflecting body, in which cleaning process the nozzles let cleaning liquid stream out towards the deflecting body and in which the spindle motor is turned on at least partially to rotate the spindle. Thus, depending on whether the spindle is equipped with the deflecting body manually or automatically, a semi-automatic or fully-automatic initiation of a cleaning process is possible.

According to a further preferred development it is provided that the deflecting body comprises a shaft which may be clamped into the spindle. Thus, the deflecting body is preferably configured such that it may be clamped into existing spindle geometries, that is to say that the shaft of the deflecting body is configured such that it may be clamped into the spindle by a chuck of the spindle.

According to a further preferred development it is provided that the machine tool comprises a working arm deflecting body having a baffle which may be moved in front of the nozzles of the spindle by the working arm, said working arm deflecting body being movable in front of the nozzles in particular with regard to its position of height. Thus, the machine tool preferably comprises—in addition to the deflecting body—a further working arm deflecting body which may be arranged in front of the nozzles of the spindle due to its movability by means of the working arm in such a way that extended distributability or else deflectability of the cleaning liquid impinging upon the working arm deflecting body may be provided.

According to a further preferred development it is provided that the working arm deflecting body fits around the spindle deflecting body of the spindle and extends at least partially around the spindle deflecting body in the operating position. Due to the configuration of the working arm deflecting body such that its shape corresponds to a negative form of the spindle deflecting body at least in sections, the working arm deflecting body may be arranged along working points to be determined along a longitudinal axis of the spindle deflecting body.

According to a further preferred development it is provided that the working arm deflecting body is adjustable with regard to its tilt by the working arm and applies different floor areas of a milling chamber of the milling machine with reflected cleaning jets via the tilt. Thus, by adjusting the tilt of the working arm deflecting body a baffle or deflection characteristic of the cleaning jets impinging upon the working arm deflecting body may be adjusted to a respective geometry of the milling chamber of the milling machine advantageously.

According to a further preferred development it is provided that the working arm deflecting body comprises an angled shaft which may be received in a chuck of the working arm. In this way, the shaft of the working arm deflecting body may be received in an existing chuck of the working arm of the machine tool.

According to a further preferred development it is provided that at the spindle deflecting body and/or the working arm deflecting body baffles are configured such that reflected cleaning jets may impinge upon any desired areas of a milling chamber of the machine tool configured as a milling machine or mill-turning machine. In this way, a baffle characteristic adjusted to the milling chamber of the machine tool may be set.

The described configurations and developments may be combined with one another at will.

Further possible configurations, developments and implementations of the invention also comprise not explicitly mentioned combinations of features of the invention described above or below with regard to the exemplary embodiments.

### SHORT DESCRIPTION OF THE DRAWINGS

The attached drawings are to convey further understanding of the embodiments of the invention. They illustrate embodiments and serve to explain principles and concepts of the invention in connection with the description.

Other embodiments and many of the advantages mentioned emerge with respect to the drawings. The illustrated elements of the drawings are not necessarily shown true to scale to one another.

FIG. 1 shows a schematic illustration of a deflecting body attached to a spindle of a machine tool according to a preferred embodiment of the invention;

FIG. 2 shows a schematic illustration of the machine tool with the spindle arranged therein and a working arm according to the preferred embodiment of the invention;

FIG. 3 shows a schematic illustration of a spindle deflecting body and a working arm deflecting body in the mounted state, respectively, according to the preferred embodiment of the invention;

FIG. 4 shows a side view of the working arm deflecting body according to the preferred embodiment of the invention;

FIG. 5 shows a schematic illustration of a baffle of the working arm deflecting body extending around the spindle deflecting body according to the preferred embodiment of the invention; and

FIG. 6 shows a flow chart of a method of operating the machine tool according to the preferred embodiment of the invention.

In the Figures of the drawings the same reference numerals refer to the same elements, parts or components, or elements, parts or components having the same function unless otherwise stated.

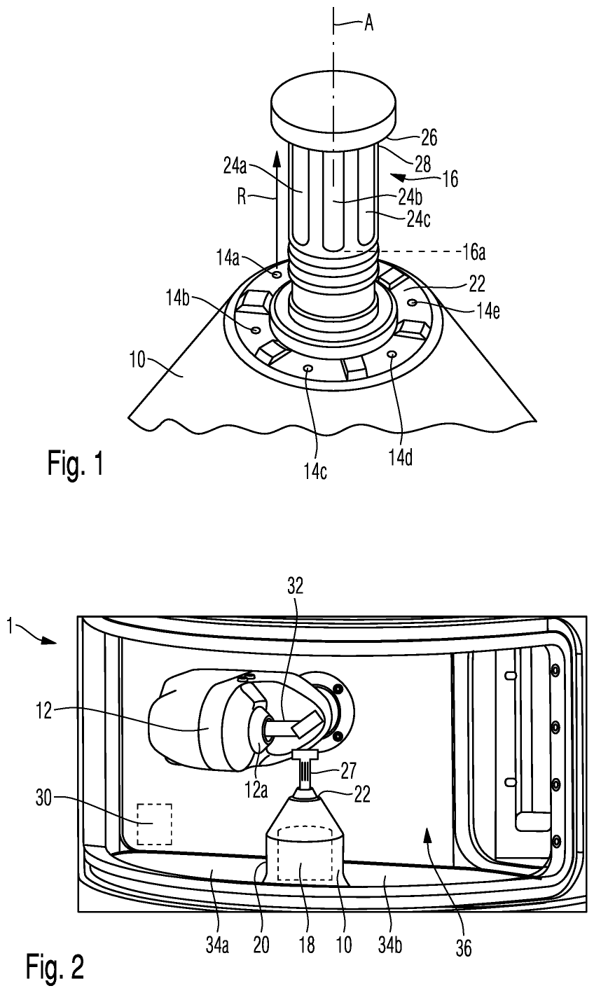

FIG. 1 shows a schematic illustration of a deflecting body attached to a spindle of a machine tool according to a preferred embodiment of the invention.

Preferably, the machine tool 1 is configured by a dental milling machine. Alternatively, the machine tool 1 may be configured e.g. by a mill-turning machine. The machine tool 1 comprises a spindle 10. The spindle 10 is configured for receiving a tool. In addition, the machine tool 1 comprises a working arm 12. The working arm 12 is configured for receiving a workpiece.

In addition, the machine tool 1 comprises a plurality of nozzles 14a, 14b, 14c, 14d, 14e and preferably a further nozzle (which is not illustrated in FIG. 1 as it is hidden by a deflecting body of the spindle). The plurality of nozzles 14a, 14b, 14c, 14d, 14e is attached to the spindle 10. Their outlet direction R is substantially parallel to the axis of rotation A of the spindle 10. The deflecting body 16 is attached to the spindle and extends in front of the respective nozzles 14a-14e. The deflecting body 16 is preferably attached to the spindle such that it is clamped therein.

Alternatively, the deflecting body 16 may be locked in place with the spindle 10, for instance. As a further alternative, the outlet directions R of the nozzles 14a-14e may point to one another obliquely and in particular point to the axis of rotation A of the spindle 10.

The deflecting body 16 is mounted pivotably and is configured such that it deflects cleaning liquid escaping from the nozzles 14a-14e. In this connection, the deflecting body 16 acts as a deflector. The cleaning liquid which impinges upon it when it is rotated is thus deflected at least partially in the direction of its rotation.

The plurality of nozzles 14a-14e is arranged preferably circularly around the spindle 10. Alternatively, the number of nozzles 14a-14e can vary or else the nozzles may be arranged in another suitable manner at the spindle 10 relative to the deflecting body 16, as for instance in a triangular, square, pentagonal or hexagonal arrangement, wherein the nozzles are arranged at respective corner points of the polygons.

The spindle 10 is connected non-rotatably with a spindle motor 18. The spindle motor 18 is received in a spindle housing 20. The spindle housing 20 is configured substantially frusto-conically, wherein the nozzles 14a-14e are configured at the front surface 22 of the spindle housing 20.

The deflecting body 16 comprises grooves 24a, 24b, 24c distributed around its circumferential surface, said grooves extending substantially parallel to the axis of rotation A of the spindle 10.

The deflecting body 16 is preferably configured substantially cylindrically. Alternatively, the deflecting body 16 may have e.g. a cornered geometry. The grooves 24a, 24b, 24c on the surface of the deflecting body 16 comprise preferably a semi-cylindrical shape. Alternatively, the grooves 24a, 24b, 24c may have another suitable shape or indentation in the surface of the deflecting body 16.

The deflecting body 16 comprises a baffle 26 whose normal extends substantially in the outlet direction R of the nozzles 14a-14e. Thus, the baffle 26 acts atomizingly on impinging jets of the cleaning liquid.

The baffle 26 is preferably configured at the end 28, in particular at the upper end of the deflecting body 16. Thus, a baffle characteristic of the baffle 26 is oriented such that spray jets of the cleaning liquid impinging upon the baffle 26 are reflected towards the bottom.

In addition, the machine tool 1 comprises a control system 30 to clean the machine tool. The control system 30 may be activated semi-automatically or fully automatically when the spindle 10 is equipped with the deflecting body 16. For instance, the spindle may be equipped with the deflecting body 16 semi-automatically, that is to say manually, or the deflecting body 16 may be arranged on the spindle 10 fully automatically by means of a suitable gripping mechanism.

During the cleaning process, the nozzles 14a-14e let cleaning liquid stream out to the deflecting body 16. The spindle motor 18 is controlled by the control system 30 during the cleaning process such that the spindle 10 rotates during the cleaning process and the deflecting body 16 sprays cleaning liquid into the work chamber of the machine tool 1 as a result of the rotation.

In addition, the deflecting body 16 comprises a shaft 16a which may be clamped into the spindle.

FIG. 2 shows a schematic illustration of the machine tool with the spindle arranged therein and a working arm according to the preferred embodiment of the invention. The working arm deflecting body is shown in a state mounted to the working arm 12. Likewise, the spindle deflecting body 16 is shown in a state mounted to the spindle 10. The working arm deflecting body 32 is positioned in a neutral position in which it has no contact with the spindle deflecting body 16 or in which it is not arranged around it. The working arm deflecting body may be positioned in a suitable desired position relative to the spindle deflecting body 16 at any time by moving the working arm 12.

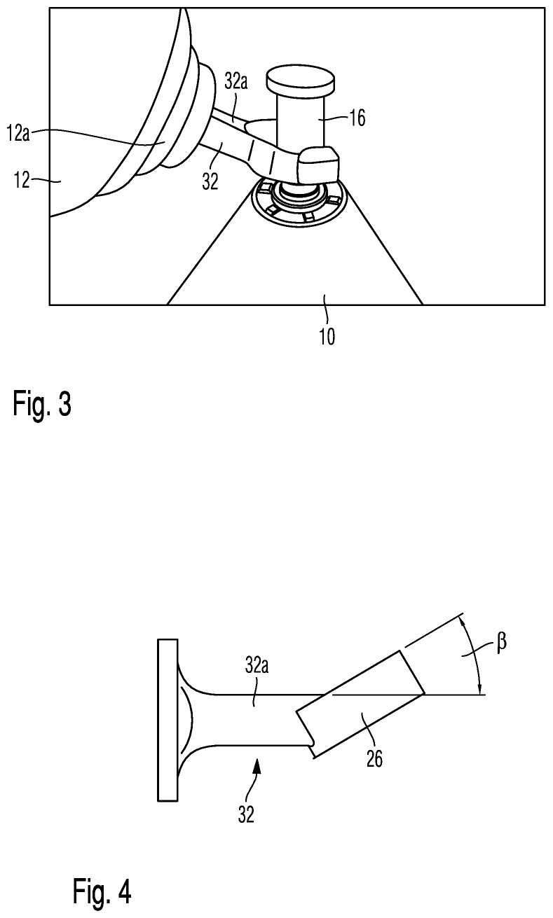

FIG. 3 shows a schematic illustration of a spindle deflecting body and a working arm deflecting body in the mounted state, respectively, according to the preferred embodiment of the invention. In the illustration shown in FIG. 3, the working arm deflecting body 32 is positioned in the milling chamber of the machine tool 1 such that its baffle extends around the circumference of the spindle deflecting body 16. In the arrangement of the working arm deflecting body 32 relative to the spindle deflecting body 16 shown in FIG. 3, the baffle characteristic may be changed advantageously such that preferably a floor area of the milling chamber of the machine tool 1 as well as a surface of the spindle 10 are applied with the cleaning liquid.

Thus, the working arm deflecting body 32 fits around the spindle deflecting body 16 of the spindle 10 and extends partially around the spindle deflecting body 16 in the operating position.

The tilt b of the working arm deflecting body 32 is movable by means of the working arm 12 and different floor areas of a milling chamber of the milling machine may be impinged upon with reflected cleaning jets via the tilt. The working arm deflecting body 32 comprises an angled shaft 32a which may be received in a chuck 12a of the working arm 12.

At the spindle deflecting body 16 and the working arm deflecting body 32 the baffles are configured such that reflected cleaning jets may impinge upon any desired areas of the milling chamber of the milling machine.

FIG. 4 shows a side view of the working arm deflecting body according to the preferred embodiment of the invention. The baffle 26 of the working arm deflecting body 32 is tilted at an angle b relative to a shaft of the working arm deflecting body 32. Preferably, the tilt angle b amounts to between 20 and 40°, particularly preferably to 30°. Due to the tilted configuration of the baffle 26 of the working arm deflecting body 32 the baffle 26 may be positioned substantially perpendicular to the axis of rotation of the spindle 10 when the working arm 12 of the machine tool 1 is tilted.

The machine tool 1 comprises the working arm deflecting body 32. It comprises the baffle 26 which may be moved in front of the nozzles (not illustrated in FIG. 4) of the spindle by the working arm 12. The working arm deflecting body 32 is configured to be movable in front of the nozzles in particular with regard to its position of height.

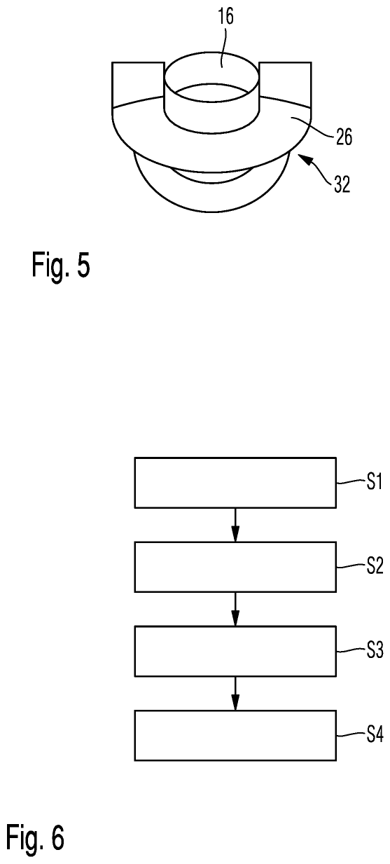

FIG. 5 shows a schematic illustration of a baffle of the working arm deflecting body, said baffle extending around the spindle deflecting body in accordance with the preferred embodiment of the invention. In the present embodiment, the baffle 26 of the working arm deflecting body 32 is configured to be semicircular or C-shaped. Thus, this configuration of the baffle 26 of the working arm deflecting body 32 may be adapted ideally to the cylindrical configuration of the spindle deflecting body 16 such that the baffle 26 of the working arm deflecting body 32 may surround the spindle deflecting body at least sectionally. When the working arm 12 is moved, the baffle 26 of the working arm deflecting body may thus be adjusted or repositioned e.g. by 180° relative to the axis of rotation A of the spindle 10 such that a changed baffle characteristic of the working arm deflecting body 32 may be produced in this way.

FIG. 6 shows a flow chart of a method of operating the machine tool according to the preferred embodiment of the invention.

The method comprises providing S1 a spindle for receiving a tool and a working arm for receiving a workpiece. Further, the method comprises providing S2 at least one nozzle which is attached to the spindle, in particular with its outlet direction substantially parallel to the axis of rotation of the spindle. In addition, the method comprises providing S3 a deflecting body which is attached to the spindle or clamped therein and which extends in particular at least partially in front of the nozzle. Additionally, the method comprises impinging upon the deflecting body with a fluid escaping from the at least one nozzle.

Although the present invention has been described above with regard to preferred exemplary embodiments, it is not limited thereto but may be modified in a variety of ways. In particular, the invention may be changed or modified in various ways without leaving the scope of the invention.

For instance, a shape, dimension and/or structure of the components of the machine tool may be changed.

1. A machine tool (1) comprising
a spindle for receiving a tool,
a working arm for receiving a workpiece, and
at least one nozzle attached to the spindle,
wherein a deflecting body is attached to the spindle or clamped therein, said deflecting body extending at least partially in front of the at least one nozzle.

2. The machine tool as claimed in claim 1,
wherein at least two nozzles are attached to the spindle, said at least two nozzles each having outlet directions (R) that point to one another obliquely and point towards the axis of rotation (A) of the spindle.

3. The machine tool as claimed in claim 1,
wherein the deflecting body is mounted pivotably,
wherein the deflecting body deflects cleaning liquid escaping from the at least one nozzle, and
wherein the deflecting body acts as a deflector and deflects cleaning liquid impinging on said deflecting body upon rotation at least partially in the direction of rotation.

4. The machine tool as claimed in claim 1,
wherein a plurality of nozzles is arranged circularly around or at the spindle and
wherein outflow directions of the plurality of nozzles point towards the deflecting body.

5. The machine tool as claimed in claim 1,
wherein the spindle is connected non-rotatably with a spindle motor which spindle motor is received in a spindle housing which spindle housing is substantially frusto-conical,
wherein the at least one nozzle is configured at the front surface of the spindle housing.

6. The machine tool as claimed in claim 1,
wherein the deflecting body comprises grooves which extend substantially parallel to an axis of rotation (A) of the spindle, and
wherein the deflecting body comprises at least one baffle having a normal extending substantially in an outlet direction (R) of the at least one nozzle,
wherein the baffle acts atomizingly with regard to impinging spray lets of cleaning liquid.

7. The machine tool as claimed in claim 6,
wherein the baffle is configured at an upper end of the deflecting body and points towards a bottom end of the deflecting body when the spray jets of the cleaning liquid are directed towards a top end of the deflecting body.

8. The machine tool as claimed in claim 1,
wherein the machine tool comprises a control system to clean the machine tool, said control system configured to turn on a cleaning process when the spindle is equipped with the deflecting body,
in which cleaning process the at least one nozzle streams cleaning liquid out towards the deflecting body and
wherein the spindle motor is turned on at least partially to rotate the spindle.

9. The machine tool as claimed in claim 1,
wherein the deflecting body comprises a shaft which is configured for clamping into the spindle (10).

10. The machine tool as claimed in claim 1,
wherein the machine tool (1) comprises a working arm deflecting body having a baffle, said baffle may be moved in front of the at least one nozzle of the spindle (10) by the working arm, said working arm deflecting body being movable in front of the at least one nozzles with regard to a position of height of the at least one nozzle.

11. The machine tool as claimed in claim 10,
wherein the working arm deflecting body fits around the spindle deflecting body of the spindle and extends at least partially around the spindle deflecting body in the operating position.

12. The machine tool as claimed in claim 10,
wherein the working arm deflecting body is movable with regard to a tilt (b) by the working arm and applies different floor areas of a milling chamber of the machine tool with reflected cleaning jets via the tilt.

13. The machine tool as claimed in claim 10,
wherein the working arm deflecting body comprises an angled shaft which is configured to be received in a chuck of the working arm.

14. The machine tool as claimed in claim 1,
wherein at the spindle deflecting body and/or the working arm deflecting body, baffles are configured such that reflected cleaning jets may impinge upon any desired areas of a milling chamber of the machine tool configured as a milling machine or mill-turning machine.

15. A method of operating a machine tool (1) comprising the steps of:
providing (S1) a spindle for receiving a tool and a working arm for receiving a workpiece;
providing (S2) at least one nozzle which nozzle is attached to the spindle having an outlet direction (R) substantially parallel to an axis of rotation (A) of the spindle;
wherein providing (S3) a deflecting body which is attached to the spindle or clamped therein and which extends at least partially in front of the nozzle (14a); and
applying (S4) the deflecting body with a fluid escaping from the at least one nozzle.

16. The machine tool as claimed in claim 1,
wherein the machine tool is a dental milling machine or mill-turning machine,
wherein the at least one nozzle attached to the spindle with an outlet direction (R) of the at least one nozzle substantially parallel to an axis of rotation (A) of the spindle.

17. The method of operating a machine tool according to claim 15, wherein the machine tool is a dental milling machine or mill-turning machine.
